(19) United States
(12) Patent Application Publication
(10) Pub. No.: US 2019/0102197 A1
(43) Pub. Date: Apr. 4, 2019

(54) SYSTEM AND METHOD FOR MERGING DIVIDE AND MULTIPLY-SUBTRACT OPERATIONS

(71) Applicant: Samsung Electronics Co., Ltd., Suwon-si (KR)

(72) Inventors: Aditya KUMAR, Austin, TX (US); Sandeep GUPTA, Austin, TX (US); Bonnie Collett SEXTON, Austin, TX (US)

(21) Appl. No.: 15/853,628

(22) Filed: Dec. 22, 2017

Related U.S. Application Data
(60) Provisional application No. 62/567,190, filed on Oct. 2, 2017.

(51) Int. Cl. G06F 9/30; G06F 9/38

(52) U.S. Cl. CPC G06F 9/30181; G06F 9/3016; G06F 9/3001; G06F 9/3867

(57) ABSTRACT

According to one general aspect, an apparatus may include a decoder circuit, a scheduler circuit, and an execution circuit. The decoder circuit may be configured to detect, within an instruction stream, a first instruction followed by a second instruction, wherein the first instruction takes as input a dividend and a divisor, and wherein the second instruction produces a remainder. The scheduler circuit may be configured to: merge the first and second instructions into a third instruction, wherein the third instruction takes as input the dividend and the divisor, and produces the remainder, replace, within an instruction pipeline, the first instruction with the third instruction, and delete, within the instruction pipeline, the second instruction. The execution circuit may be configured to execute the third instruction.

### CROSS-REFERENCE TO RELATED APPLICATION

This application claims priority under 35 U.S.C. § 119 to Provisional Patent Application Ser. No. 62/567,190, entitled “SYSTEM AND METHOD FOR MERGING DIVIDE AND MULTIPLY-SUBTRACT OPERATIONS” filed on Oct. 2, 2017. The subject matter of this earlier filed application is hereby incorporated by reference.

### TECHNICAL FIELD

This description relates to circuits. In particular, the present disclosure relates to a system and method for merging divide and multiply-subtract operations.

### BACKGROUND

In computing, the modulo operation finds the remainder after division of one number by another (sometimes called modulus). In division, the dividend is divided by the divisor to get a quotient. The remainder is the amount “left over” after performing some computation.

Given two numbers, a (the dividend) and n (the divisor), a modulo n (abbreviated as “mod n”) is the remainder of the Euclidean division of a by n. For example, the expression “5 mod 2” would evaluate to 1 because 5 divided by 2 leaves a quotient of 2 and a remainder of 1, while “9 mod 3” would evaluate to 0 because the division of 9 by 3 has a quotient of 3 and leaves a remainder of 0; there is nothing to subtract from 9 after multiplying 3 times 3.

A typical instruction set architecture (ISA) (e.g., ARM AArch64 ISA) does not provide a modulo instruction to compute a remainder when a divisor and a dividend are provided. This often results in inefficient code when remainder is required to be computed in a program. Essentially, it requires a division, and then a multiplication and a subtraction to get the remainder. This results in a loss of performance when, as during the process of division, the remainder is readily computed by the hardware.

### SUMMARY

According to one general aspect, an apparatus may include a decoder circuit, a scheduler circuit, and an execution circuit. The decoder circuit may be configured to detect, within an instruction stream, a first instruction followed by a second instruction, wherein the first instruction takes as input a dividend and a divisor, and wherein the second instruction produces a remainder. The scheduler circuit may be configured to: merge the first and second instructions into a third instruction, wherein the third instruction takes as input the dividend and the divisor, and produces the remainder, replace, within an instruction pipeline, the first instruction with the third instruction, and delete, within the instruction pipeline, the second instruction. The execution circuit may be configured to execute the third instruction.

According to another general aspect, an apparatus may include an instruction pipeline that includes a plurality of pipeline stage circuits, and configured to process a stream of instructions in a partially parallel manner. The plurality of pipeline stage circuits may include a first circuit configured to detect, within the instruction stream, an integer division instruction followed by a multiply-subtract instruction, wherein the integer division instruction and the multiply-subtract instruction, together, produces a remainder. The plurality of pipeline stage circuits may include a second circuit configured to: replace, within the instruction stream, the integer division instruction with a modulo instruction, and delete, within the instruction stream, the multiply-subtract instruction.

According to another general aspect, a method may include detecting, by a first portion of an instruction pipeline circuitry, if a division instruction followed by a subtraction instruction results in a modulo operation. The method may include merging, by a second portion of an instruction pipeline circuitry, the division and subtraction instructions into a merged instruction that, when executed, performs the modulo operation. The method may further include executing, by a third portion of the instruction pipeline circuitry, the merged instruction.

The details of one or more implementations are set forth in the accompanying drawings and the description below. Other features will be apparent from the description and drawings, and from the claims.

A system and/or method for merging divide and multiply-subtract operations, substantially as shown in and/or described in connection with at least one of the figures, as set forth more completely in the claims.

### BRIEF DESCRIPTION OF THE DRAWINGS

FIG. 1 is a block diagram of an example embodiment of a system in accordance with the disclosed subject matter.

FIG. 2 is a block diagram of an example embodiment of a system in accordance with the disclosed subject matter.

FIG. 3 is a timing diagram of an example embodiment of an instruction pipeline in accordance with the disclosed subject matter.

FIG. 4 is a timing diagram of an example embodiment of a circuit in accordance with the disclosed subject matter.

FIG. 5 is a schematic block diagram of an information processing system that may include devices formed according to principles of the disclosed subject matter.

Like reference symbols in the various drawings indicate like elements.

### DETAILED DESCRIPTION

Various example embodiments will be described more fully hereinafter with reference to the accompanying drawings, in which some example embodiments are shown. The present disclosed subject matter may, however, be embodied in many different forms and should not be construed as limited to the example embodiments set forth herein. Rather, these example embodiments are provided so that this disclosure will be thorough and complete, and will fully convey the scope of the present disclosed subject matter to those skilled in the art. In the drawings, the sizes and relative sizes of layers and regions may be exaggerated for clarity.

It will be understood that when an element or layer is referred to as being “on,” “connected to” or “coupled to” another element or layer, it may be directly on, connected or coupled to the other element or layer or intervening elements or layers may be present. In contrast, when an element is referred to as being “directly on”, “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third, and so on may be used herein to describe various elements, components, regions, layers and/or sections, these elements, components, regions, layers and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of the present disclosed subject matter.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” may encompass both an orientation of above and below. The device may be otherwise oriented (rotated 90 degrees or at other orientations) and the spatially relative descriptors used herein interpreted accordingly.

Likewise, electrical terms, such as “high” “low”, “pull up”, “pull down”, “1”, “0” and the like, may be used herein for ease of description to describe a voltage level or current relative to other voltage levels or to another element(s) or feature(s) as illustrated in the figures. It will be understood that the electrical relative terms are intended to encompass different reference voltages of the device in use or operation in addition to the voltages or currents depicted in the figures. For example, if the device or signals in the figures are inverted or use other reference voltages, currents, or charges, elements described as “high” or “pulled up” would then be “low” or “pulled down” compared to the new reference voltage or current. Thus, the exemplary term “high” may encompass both a relatively low or high voltage or current. The device may be otherwise based upon different electrical frames of reference and the electrical relative descriptors used herein interpreted accordingly.

The terminology used herein is for the purpose of describing particular example embodiments only and is not intended to be limiting of the present disclosed subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized example embodiments (and intermediate structures). As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosed subject matter.

Unless otherwise defined, all terms (including technical and scientific terms) used herein have the same meaning as commonly understood by one of ordinary skill in the art to which this disclosed subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, example embodiments will be explained in detail with reference to the accompanying drawings.

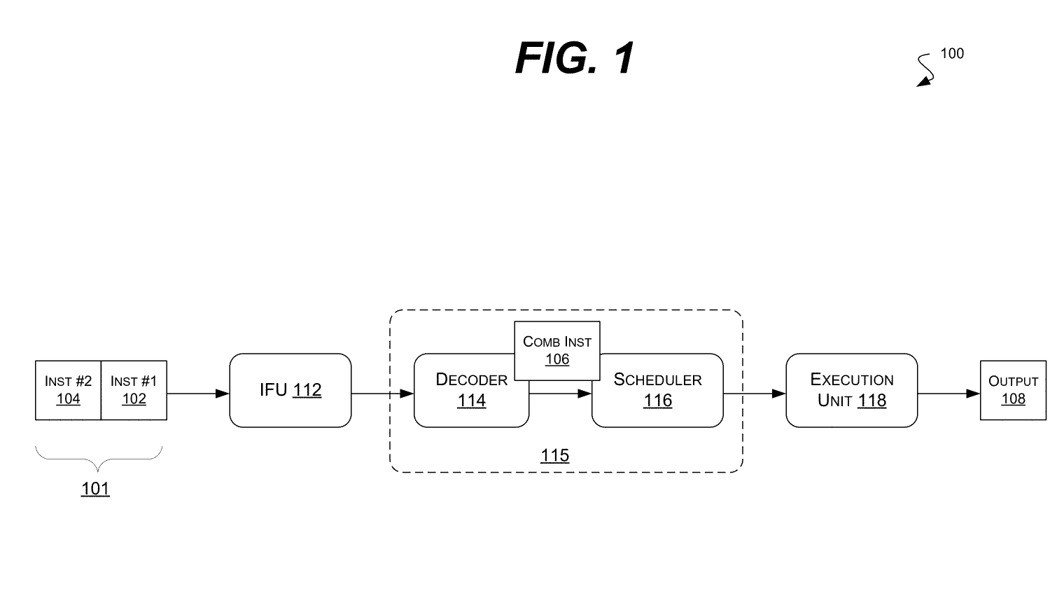

FIG. 1 is a block diagram of an example embodiment of a system 100 in accordance with the disclosed subject matter. In various embodiments, the system 100 may be included as part of a processor, a system-on-a-chip (SoC), instruction pipeline or other computer architecture circuit.

In the illustrated embodiment, the system 100 may include a plurality of circuits arranged or grouped in to portions referred to as “units”. Each unit or circuit may include various pieces of combinatorial logic circuits (e.g., AND, NOR gates, etc.) and/or memory circuits (e.g., flip-flops, registers, memory cells, etc.). It is understood that the above are merely a few illustrative examples to which the disclosed subject matter is not limited.

In the illustrated embodiment, the system 100 may include an instruction pipeline in which a series or stream of instructions 101 are processed by the system 100 in a substantially, staggered, or partially parallel fashion or manner. Generally, the processing of the instruction stream 101 occurs in stages (pipeline stages) such that a first instruction 102 may be partially processed by a first stage then passed to a second stage for continued processing. Then a second instruction 104 may be processed by the first stage while the first instruction 102 is processed by the second stage, and so on. In various embodiments, the pipeline may branch, stall, flush, or otherwise involve complex processing (not shown).

In the illustrated embodiment, the system 100 may include an instruction fetch unit or circuit (IFU) 112. The IFU 112 may be configured to fetch or retrieve instructions 101 from a memory (not shown), and generally place instructions 101 into the pipeline. Each instruction 101 may dictate an operation the system 100 is to take.

Generally, the instructions 101 are defined for a given processor by the company that created processor, and the list of defined instructions is referred to as the instruction set architecture (ISA). When a program gets compiled into an executable form, the compiler makes use of only the defined instructions from the ISA. If the compiler where to use an undefined instruction, a processor attempting to execute the program would not understand what instruction the program is attempting to convey. Therefore, general purpose programs must follow a given ISA.

In the illustrated embodiment, the system 100 may include a decoder circuit 114. In various embodiments, the decoder circuit 114 may be configured to determine what operation the instruction 101 is, and how it should be processed by the pipeline. For example, the decode circuit 114 may recognize a floating-point instruction and route it towards the floating-point execution unit. Whereas a load instruction (to load data from memory) may be routed to the load-store unit. It is understood that the above are merely a few illustrative examples to which the disclosed subject matter is not limited.

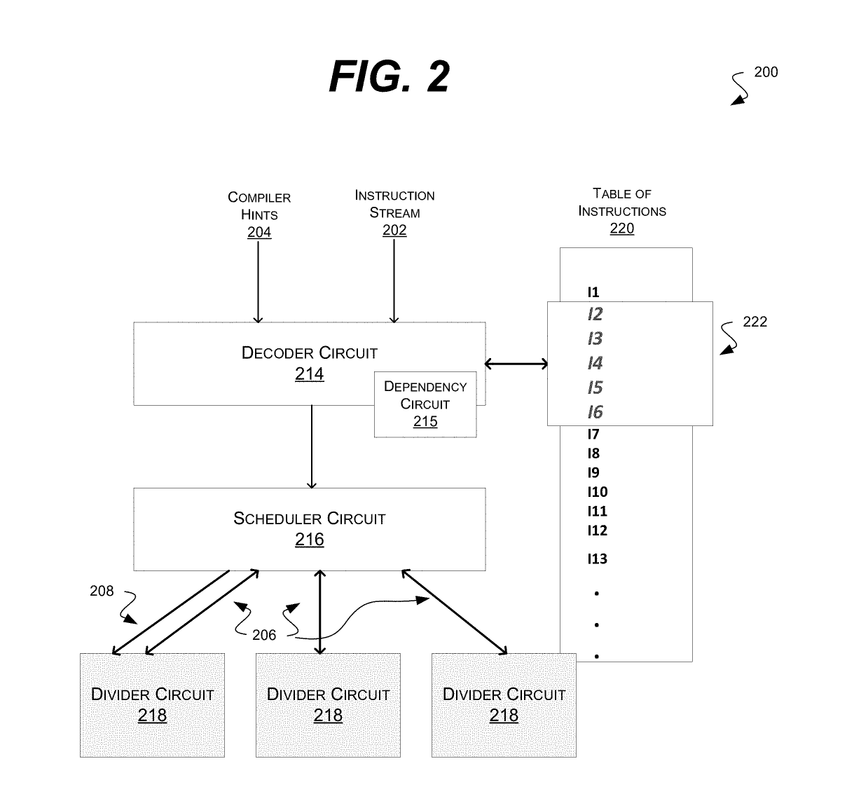

In the illustrated embodiment, the system 100 may include a scheduler circuit 116. In various embodiments, the scheduler circuit 116 may be configured to schedule the execution of the instruction 101. In various embodiments, this may include rearranging the order of instructions within the stream (e.g., out of order execution, etc.). In another embodiment, this may include routing an instruction 101 to one of a plurality of execution units 118 (shown in FIG. 2). In various embodiments, the decoder circuit 114 and scheduler circuit 116 may be included in a common unit, such as, for example an instruction decode unit (IDU) 115. It is understood that the above is merely one illustrative example to which the disclosed subject matter is not limited.

In the illustrated embodiment, the system 100 may include one or more execution circuit or units 118. Each execution unit 118 is configured to execute or perform the operation dictated by a given instruction. In various embodiments, the execution unit 118 may include a load-store unit, an arithmetic logic unit, a floating-point unit, a shader unit, etc.

In the illustrated embodiment, as described above, the stream of instructions 101 may include only instructions defined by the ISA. Also as described above, in various embodiments, many ISA do not define a modulo instruction. Typically, the modulo operation is performed by two (or more) instructions. First a division instruction (e.g., an integer division such as sdiv) will compute the quotient (taking the dividend and divisor as input). Then a multiple-subtract instruction (e.g., msub) will compute the remainder (taking the dividend, divisor, and quotient as input) by multiplying the quotient by the divisor and subtract that from the dividend. This is almost always inefficient as the multiple-subtract instruction has to wait until the execution unit 118 has processed the division instruction (and output the quotient). Also, the execution unit 118 (and other units) are occupied by the two (or more) instructions and therefore unavailable to process the rest of the instruction stream 101.

In the illustrated embodiment, the system 100 (e.g., the decoder circuit 114) may be configured to detect a first instruction 102 followed by a second instruction 104. In various embodiments, the two instructions 102 and 104 may be separated, in the instruction stream 101, by intervening instructions (not shown). In various embodiments, these two instructions 102 and 104 may produce a final result (e.g., a remainder) in two (or more) parts (e.g., division, and multiply and substract).

In such an embodiment, the scheduler circuit 116 may be configured to essentially combine the first and second instructions 102 and 104 into a third instruction 106. In various embodiments, the third or combined instruction 106 may not be included in the ISA.

In various embodiments, the third instruction 106 may be placed in the instruction stream 101 (which is already in the pipeline). In such an embodiment, the first instruction 102 may be removed from the instruction stream 101 and the third instruction 106 put in its place. Likewise, the second instruction 104 may be removed from the instruction stream 101. In such an embodiment, the instruction stream 101 may be shortened, and the system 100 may reap the benefits of having one less instruction to process.

In various embodiments, this detection, merging and editing of the instruction stream 101 may be performed, in whole or part, by any portions of the decoder or scheduler circuits 114 & 116, or by a renaming circuit (not shown). In various embodiments, these operations may be performed as part of the general Instruction Decode portion of the pipeline. A textbook example of an instruction pipeline may include the traditional five stages: instruction fetch, instruction decode, execution, memory access, and writeback. However, modern processor implementations break these traditional stages into many smaller portions. It is understood that the above are merely a few illustrative examples to which the disclosed subject matter is not limited.

In such an embodiment, the execution unit 118 may be configured to perform the third instruction 118 and output the result 108. In various embodiments, the output 108 may include the desired output of the second instruction 104, but use the inputs of the first instruction 102. In another embodiment, both the outputs of the first and second instructions 102 & 104 may be generated.

For example, if the first instruction 102 is a division instruction and takes as input the dividend and the divisor, and the second instruction 104 is a multiply-subtract instruction that outputs a remainder, the third instruction 106 may be a modulo instruction (which may not be included in the ISA) that takes as input the dividend and the divisor, and outputs a remainder. In various embodiments, the first instruction 106 may output the quotient. And, the third instruction 106 may also output the quotient or all the outputs of the first and second instructions 104 and 102. In such an embodiment, the system 100 may be assured that no other instructions in the stream 101 may fail because they expected to use an output from the first or second instructions 102 & 104 (which is now replaced with the third instruction 106).

FIG. 2 is a block diagram of an example embodiment of a system 200 in accordance with the disclosed subject matter. In various embodiments, the system 200 may be included as part of a processor, a system-on-a-chip (SoC), instruction pipeline or other computer architecture circuit.

In various embodiments, the system 200 may include a decoder circuit 214, a scheduler circuit 216, and a plurality of execution units or divider circuits 218. In the illustrated embodiment, a stream of instructions 202 may be processed by the system 200, as described above.

As described above, in various embodiments, the decoder circuit 214 may be configured to detect, within the instruction stream 202, when a first instruction is followed by a second instruction. In such an embodiment, the first instruction may include an integer division, and the second instruction may include a multiply-subtract instruction. In another embodiment, the decoder circuit 214 may detect a plurality of instructions, such as a division instruction, followed by a multiply instruction, followed by a subtract instruction.

In such an embodiment, the decoder circuit 214 may detect not only that the two instructions occur within the stream 202, but that they are organized or arranged to complete a specific task (e.g., the modulo operation). In such an embodiment, the instructions may have common inputs (e.g., a divisor, a dividend) and the second instruction may take as input the output of the first instruction (e.g., the quotient). In various embodiments, other relationships between the two instructions may indicate their related nature and common ultimate purpose. It is understood that the above are merely a few illustrative examples to which the disclosed subject matter is not limited.

In the illustrated embodiment, the system 200 or the decoder circuit 214 may include a memory or table of instructions 220. In such an embodiment, the table of instructions 220 may include a portion of the stream of instructions 202 (e.g., instructions I1, I2, I3, I4, I5, I6, I7, I8, I9, I10, I11, I12, I13, and so on). The decoder circuit 214 may be configured to only look for, or detect the two instructions if they occur within a window 222, certain time period, or portion of the instruction stream 202. In various embodiments, all the instructions within the memory 220 may be included within the window 222. In another embodiment, the window 222 may merely include a sub-portion of the larger portion of the instruction stream 202 stored within the memory or table 220. It is understood that the above are merely a few illustrative examples to which the disclosed subject matter is not limited.

In various embodiments, by limiting search for the two associated instructions to the window 222 of observable instructions the likelihood of association between any two instructions may increase. For example, the further away (in the stream 202) two instructions are the less likely they can be combined to produce the third instruction. In another embodiment, by limiting search for the two associated instructions to the window 222 of observable instructions the circuitry required in the decoder circuit 214 may be reduced. In various embodiments, the size of the window 222 may be predefined or fixed (e.g., to 5 instructions) or the size may be configurable.

In various embodiments, the decoder circuit 214 may include a dependency detection circuit 215. In such an embodiment, the dependency detection circuit 215 may be configured to determine if the second instruction is dependent upon an output of the first circuit, and based upon that determine indicate that the first and second instructions may or may not be merged.

In some embodiments, the dependency detection circuit 215 may also be configured to determine if there are dependencies (e.g., between outputs and inputs) of instructions that would prevent the first and second instructions from being combined. In such an embodiment, this may be characterized as a violation of a dependency rule. For example, if the third or merged instruction does not produce the same output as both the first and second instructions (e.g., a remainder but no quotient), but a fourth instruction makes use of that missing output (e.g., the quotient), then a dependency would exist that would cause the first and second instructions not to be merged. In another embodiment, the dependency detection circuit 215 may determine if another or intervening instruction may change an output of the first instruction (e.g., the register that stores the quotient) before the second instruction may use it as an input. In such an embodiment, the second instruction may be dependent upon an action taken by the intervening instruction, and the first and second instructions may not be merged. It is understood that the above are merely a few illustrative examples to which the disclosed subject matter is not limited.

As described above, in one embodiment, the third instruction may output all of the outputs of both the first and second instructions (thus avoiding a number of dependency issues). In another embodiment, the third instruction may output fewer outputs (e.g., the remainder but not the quotient). As described above, this may be dangerous as a dependency upon the discarded (or un-computed) output may exist. However, in various embodiments, a plurality of merged instructions with varying numbers of outputs may exist (e.g., with all outputs, with only the remainder). In such an embodiment, the dependency detection circuit 215 may be configured to determine which of the plurality of merged instructions to select and to be placed into the instruction stream 202.

In one embodiment, (unlike the embodiment shown in FIG. 1) the decoder circuit 214 may be configured to, once the two related instructions are identified, create the third, combined instruction (e.g., the modulo instruction). The decoder circuit 214 may then insert the third or merged instruction into the stream 202 (replacing the first and second instructions, as described above). The decoder circuit 214 may send the new instruction to the scheduler circuit 216. As described above, in various embodiments, merging, replacement, and deleting actions taken may be performed by a number of different circuits (e.g., the decoder circuit 214, the scheduler circuit 216).

In the illustrated embodiment, the scheduler circuit 216 may be configured to accept the third, merged instruction. The scheduler circuit 216 may select which of the divider circuits 218 will execute the third instruction. The scheduler circuit 216 may then send the third instruction to the divider circuit 218 for execution.

In various embodiments, the scheduler circuit 216 may send the third instruction (along with its inputs and outputs, or at least a pointer to them) via the instruction message 206. In another embodiment, for the special merged or third instruction, the scheduler circuit 216 may also indicate to the divider circuit 218 that a modulo operation is taking place and that the computed remainder should not be discarded (as is often done with a traditional ISA instruction), but should be saved. In such an embodiment, this may include a modulo message or bit 208. It is understood that the above is merely one illustrative example to which the disclosed subject matter is not limited.

In the illustrated embodiment, the divider circuit 218 may execute the third instruction and save the outputs to the assigned registers (not shown). In the case of the modulo instruction, the divider circuit 218 may output the remainder and/or the quotient. In some embodiments, the divider circuit 218 (or whatever execution circuit is appropriate for the instruction) may be configured to output all of the third instruction's outputs in the same clock cycle. In another embodiment, the divider circuit 218 may be configured to finish outputting the third instruction's outputs before or at the same clock cycle as the second instruction would have completed (and generated outputs) had it not been removed from the instruction stream. In such an embodiment, the third instruction may complete at least as soon as the second instruction would have, and frequently when the first instruction would have (had it not been replaced by the third instruction). It is understood that the above are merely a few illustrative examples to which the disclosed subject matter is not limited.

In various embodiments, the instruction stream 202 may include or be associated with one or more compiler hints 204. As described above, the compiler translates a program's source code to executable instructions, where the instructions are defined by the ISA. As part of that, a compiler may also insert special hints, bit flags, or indications into the instructions stream or a parallel stream. These compiler hints 204 may be read by the system 200 may used to make decisions within the instruction pipeline. For example, traditional compiler hints may include branch prediction information.

In the illustrated embodiment, the compiler hints 204 may include indications as to whether or not the first and second instructions may be combined. Generally, a compiler, which gets to analyze a program as a whole and not as a stream that is revealed one instruction at a time, may understand the operation of a program more completely than the processor or system 200. As such, the compiler may understand that what the programmer or user desired was the operation provided by the third instruction (e.g., a modulo operation) but, due to the limitations of the ISA, the compiler had to use the first and second instructions (e.g., sdiv and msub). In such an embodiment, the compiler may include a compiler hint 204 in the instruction stream that indicates to the decode circuit 214 that the first and second instructions may be combined into the third instruction.

In various embodiments, the decoder circuit 214 may rely upon these compiler hints 204 to various degrees. In one embodiment, the decoder circuit 214 may only combine when a compiler hint 204 says to. In another embodiment, the decoder circuit 214 may combine when the compiler hint 204 says to, but may opportunistically combine when the decoder circuit 214 detects the first and second instructions. In yet another embodiment, the decoder circuit 214 may combine when the instruction stream 202 includes (or is associated with) compiler hints 204 and the compiler hint 204 says to. But if the instruction stream 202 does not include any merge-related compiler hints 204, the may decoder circuit 214 combine when it detects the first and second instructions. In yet another embodiment, the decoder circuit 214 may opportunistically combine when the decoder circuit 214 detects the first and second instructions, bit not combine when the compiler hint 204 says not to. It is understood that the above are merely a few illustrative examples to which the disclosed subject matter is not limited.

In such an embodiment, the compiler hints 204 may indicate which of the outputs of the first and second instructions are needed. As described above, in various embodiments, versions of the merged or third instruction may output a different number of outputs, such as all the outputs of the first and second instructions (e.g., quotient and remainder) or a less number (e.g., just the reminder). As described above, it may be difficult for the dependency detection circuit 215 to know if an output will not be needed (especially of the instruction needing the output is outside the window 222). In such an embodiment, the compiler hint 204 may indicate the need or lack thereof for any outputs.

In some embodiments, the compiler hints 204 may turn the combining ability of the decoder circuit 214 on or off. In such an embodiment, the decoder circuit 214 may monitor the compiler hints 204 to begin searching for the first and second instructions, or conversely to stop searching. In various embodiments, the decoder circuit 2014's default mode may be the detection and combining of the two instructions. Whereas, in another embodiment, the decoder circuit 2014's default mode may be to not detect or combine the two instructions until instructed otherwise.

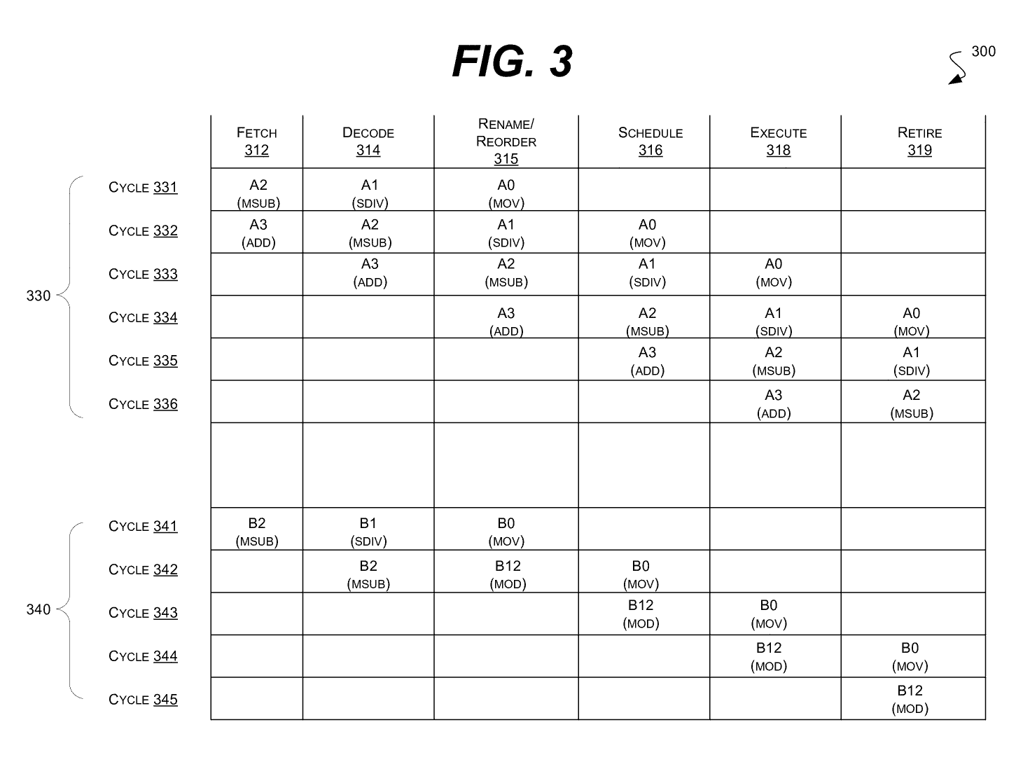

FIG. 3 is a timing diagram of an example embodiment of an instruction pipeline 300 in accordance with the disclosed subject matter. In various embodiments, the instruction pipeline 300 may be included as part of a processor, a system-on-a-chip (SoC), or other computer architecture circuit.

In the illustrated embodiment, the instruction pipeline 300 may include a fetch circuit 312, a decode circuit 314, a rename-and-reorder (rename/reorder) circuit 315, a schedule circuit 316, an execute circuit 318 (e.g., a divider circuit), and a retire circuit 319. In the illustrated embodiment, each of these circuits may be associated with their own stage of the instruction pipeline.

In the illustrated embodiment, two sets of clock cycles 330 & 340 are shown. For the sake of simplicity of illustration, each stage is assumed to take one clock cycle. The clock cycles 330 show the operation of a stream of instructions in which none of the instructions are combined into a merged or third instruction. The clock cycles 340 show the operation of a stream of instructions in which two of the instructions are combined into a merged or third instruction.

In the illustrated embodiment, the instruction A0 may include a move (mov) instruction that moves data between registers. The instruction A1 may include a signed integer division (sdiv) instruction that takes as input the dividend and divisor and returns or outputs a quotient. The instruction Al may have the form sdiv(dividend, divisor, quotient), where the values in the parentheses are registers where data is stored or to be placed. The instruction A2 may include a multiply-subtract (msub) instruction that takes as input the dividend, divisor, and quotient, and returns or outputs a remainder. The instruction A2 may have the form msub(dividend, divisor, quotient, remainder), where the values in the parentheses are registers where data is stored or to be placed. The instruction A3 may include an addition (add) instruction that adds two values together. It is understood that the above are merely a few illustrative examples to which the disclosed subject matter is not limited.

In the illustrated embodiment, cycle 331 shows the stream of instructions A0, A1, A2, and A3 partially entered into the pipeline 300. Instruction A0 is in the rename/reorder stage 315. Instruction A1 is in the decode stage 314. Instruction A2 is in the fetch stage 312. And, instruction A3 has yet to enter the pipeline 300. In various embodiments, the decode stage 315 may detect that an instruction that meets the criteria of the first instruction (e.g., an integer divide instruction) is in the pipeline 300.

Cycle 332 shows the instruction A0 move to the schedule stage 316, instruction A1 move to the rename/reorder stage 315, the instruction A2 move to the decode stage 314, and the instruction A3 enter the pipeline at the fetch stage 312. In various embodiments, the decode stage 314 may detect that the instruction A2 meets the primary criteria of the second instruction (e.g., a multiply-subtract instruction). But, in the illustrated embodiment, for whatever reason the instruction A2 or the instructions A1 & A2 in combination may not be combined into the merged instruction (e.g., the modulo instruction). In one embodiment, the instruction A2 may not use the output of instruction A1 (i.e., they are unrelated instructions). In another embodiment, there may be a dependency within the instruction stream that prevents or counsels against the combination. In yet another embodiment, a compiler hint may instruct against the merger. In one embodiment, the ability to combine instructions may simply be turned off. It is understood that the above are merely a few illustrative examples to which the disclosed subject matter is not limited.

Cycles 333, 334, 335, and 336 show the instructions A0, A1, A2, and A3 moving through the instruction pipeline. If the combined effect of instructions A1 & A2 is to produce a remainder, that does not occur until the 5^{th} cycle (cycle 336) from the time the instruction A2 was fetched. Cycle 336 is when the instruction A2 is retired or finally executed, and its results (e.g., the remainder) are correct and visible in the architectural state of the processor. In various embodiments, had the instructions A1 and A2 been separated by intervening instructions or had the instruction A2 been scheduled to wait or be delayed until the output of instruction A1 had completed, the completion or retirement of instruction A2 would have occurred even later.

In the illustrated embodiment, the instruction B0 may include a move (mov) instruction that moves data between registers. The instruction B1 may include a signed integer division (sdiv) instruction that takes as input the dividend and divisor and returns or outputs a quotient. The instruction B2 may include a multiply-subtract (msub) instruction that takes as input the dividend, divisor, and quotient, and returns or outputs a remainder. It is understood that the above are merely a few illustrative examples to which the disclosed subject matter is not limited.

In the illustrated embodiment, cycle 341 shows the stream of instructions B0, B1, and B2 fully entered into the pipeline 300. Instruction B0 is in the rename/reorder stage 315. Instruction B1 is in the decode stage 314. Instruction B2 is in the fetch stage 312. In various embodiments, the decode stage 315 may detect that an instruction that meets the criteria of the first instruction (e.g., an integer divide instruction) is in the pipeline 300, as instruction B1.

At cycle 342, the instructions may advance with instruction B0 moving to the schedule stage 316. The instruction B1 may move to the rename/reorder stage 315. And, the instruction B2 may move to the decode stage 314.

In the illustrated embodiment, the decode stage 315 may detect that the instruction B2 meets the criteria of the second instruction (e.g., a multiply-subtract instruction). Further, in the illustrated embodiment, the instructions B1 and B2 may meet the other criteria (e.g., related, dependency, and/or compiler hint) to be combined.

In the illustrated embodiment, the rename/reorder stage or circuit 315 may be configured to merge, replace, and delete the targeted instructions. This differs from the embodiment of FIG. 1 in which the scheduler circuit performed this task, and the embodiment of FIG. 2, in which the decode circuit performed this task. It is understood that the above are merely a few illustrative examples to which the disclosed subject matter is not limited.

In the illustrated embodiment, the rename/reorder stage or circuit 315 may generate a merged instruction B12. The instruction B12 may include a modulo (mod) instruction that is not found in the processor's ISA. The instruction B12 may takes as input the dividend and divisor, and return or output the quotient and remainder. The instruction B12 may have the form mod(dividend, divisor, quotient, remainder), where the values in the parentheses are registers where data is stored or to be placed. It is understood that the above is merely one illustrative example to which the disclosed subject matter is not limited.

In such an embodiment, the rename/reorder stage or circuit 315 may replace, within the instruction stream, the instruction B1 with the merged instruction B12. Further, the decode stage 314 may be configured to not pass or forward the instruction B2 to the next stage or cycle 343. This may effectively delete the instruction B2 from the instruction stream.

Cycles 343, 344, and 345 show the instructions B0 and B12 moving through the instruction pipeline. In the illustrated embodiment, the combined instruction B12 produces the remainder on the 4^{th} cycle (cycle 345) from the time the instruction B2 was fetched. In the illustrated embodiment, this reduces the execution time of the remainder by one cycle. And, as described above, the reduction in execution time may be even greater if the instructions B1 and B2 are separated by more than the cycle shown. Further, the execution of the quotient occurs exactly when it would have had instruction B1 been allowed to proceed. In addition, efficiencies are gained by being able to use the execution stage 318 for another instruction (not shown) during cycle 345 when it would have been processing the deleted instruction B2. It is understood that the above are merely a few illustrative examples to which the disclosed subject matter is not limited.

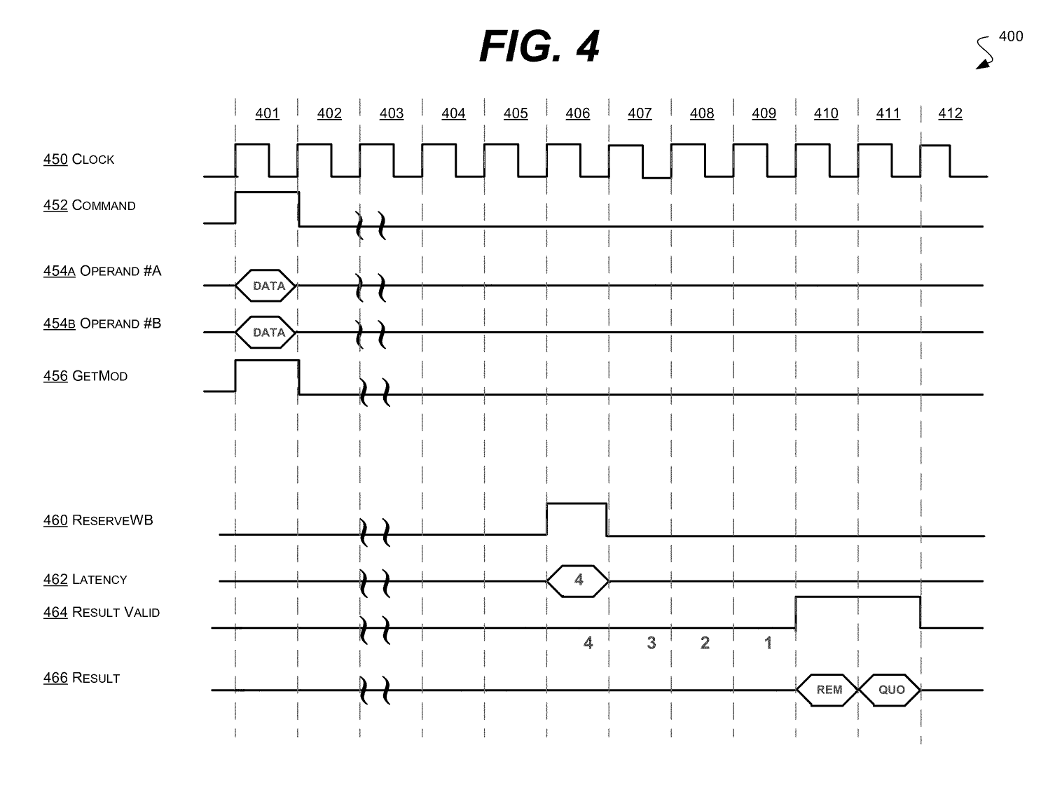

FIG. 4 is a timing diagram of an example embodiment of a circuit 400 in accordance with the disclosed subject matter. In various embodiments, the circuit 400 may include an execution circuit, such as, for example a divider circuit, as described above. In various embodiments, the circuit 400 may be included as part of a processor, a system-on-a-chip (SoC), or other computer architecture circuit.

In the illustrated embodiment, the timing diagram illustrates the inputs and outputs, and more generally the signals that may be send to or received from a divider circuit when the merged instruction (e.g., a modulo instruction) is sent to it. It is understood that the above is merely one illustrative example to which the disclosed subject matter is not limited.

In the illustrated embodiment, a clock signal 450 may be employed to synchronize and time the circuit 400. A command signal 452 may be configured to indicate that a new instruction or command is being applied to the circuit 400. Operand signals 454A and 454B may be configured to input data values, associated with the instruction, to the circuit 400. In the illustrated embodiment, the operand 454A may include a dividend, and operand 454B may include a divisor. The GetMod or get modulo signal 456 may be configured to indicate that the circuit 400 is to output (as opposed to discard or not compute) the remainder of the division operation. It is understood that the above are merely a few illustrative examples to which the disclosed subject matter is not limited.

In the illustrated embodiment, the reserve writeback (ReserveWB) signal 460 may be configured to indicate that the circuit 400 intends to write data back to a memory or register. The latency signal 462 may be configured to indicate the number of cycles before such a write back is expected to occur. The result valid signal 464 may be configured to indicate that desired result is ready for storage or writing. The result signal 466 may be configured to output the desired result or results (e.g., the quotient, remainder). It is understood that the above are merely a few illustrative examples to which the disclosed subject matter is not limited.

In the illustrated embodiment, at the first cycle (cycle 401 the scheduler circuit or other circuit may instruct the circuit 400 (via the command signal 452) that circuit 400 should execute an instruction and that the associated data or operands are being input to the circuit 400. In such an embodiment, the dividend and divisor may be placed on the operand signals 454A and 454B. As described above, the GetMod signal 456 may be asserted to indicate that the circuit 400 should also return the remainder or modulus.

In the illustrated embodiment, the computation of the division operation may take a number of clock cycles (e.g., cycles 402, 403, 404, and 405). At cycle 406 the circuit 400 may indicate (via the reserveWB signal 460 and the Latency signal 462) that outputs (e.g., remainder and quotient) will be ready for output starting in four cycles.

In the illustrated embodiment, After the four cycles (cycles 406, 407, 408, and 409) have passed, the circuit 400 may assert the Result Valid signal 464, and place the outputs on the result signal 466. In the illustrated embodiment, each output may be placed, in turn, on the result signal 466 one at a time. In such an embodiment, the two outputs, remainder and quotient, may occur over cycles 410 and 411. In another embodiment, multiple result signals 466 may be employed and the outputs may be transmitted to the processor in parallel. It is understood that the above is merely one illustrative example to which the disclosed subject matter is not limited.

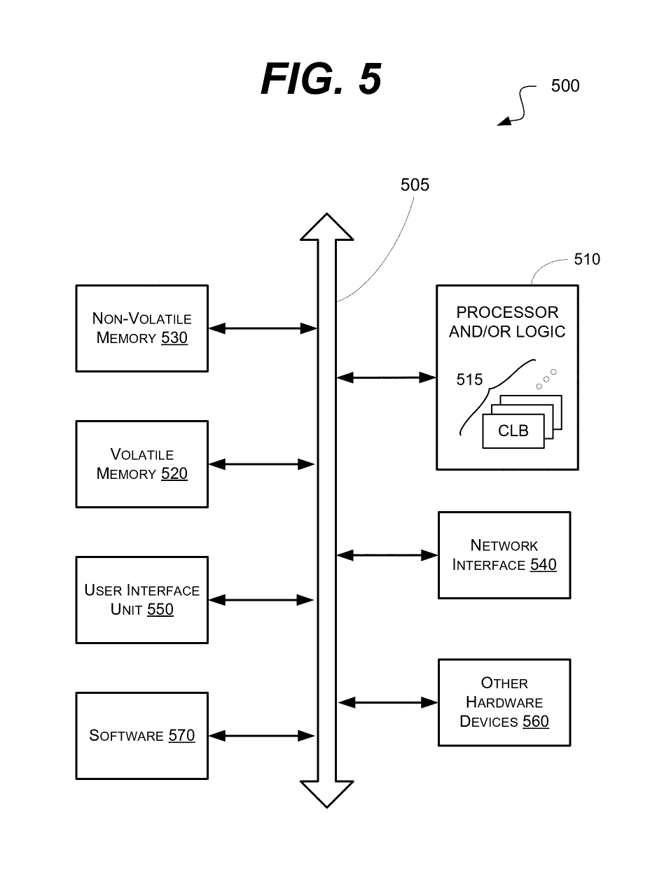

FIG. 5 is a schematic block diagram of an information processing system 500, which may include semiconductor devices formed according to principles of the disclosed subject matter.

Referring to FIG. 5, an information processing system 500 may include one or more of devices constructed according to the principles of the disclosed subject matter. In another embodiment, the information processing system 500 may employ or execute one or more techniques according to the principles of the disclosed subject matter.

In various embodiments, the information processing system 500 may include a computing device, such as, for example, a laptop, desktop, workstation, server, blade server, personal digital assistant, smartphone, tablet, and other appropriate computers or a virtual machine or virtual computing device thereof. In various embodiments, the information processing system 500 may be used by a user (not shown).

The information processing system 500 according to the disclosed subject matter may further include a central processing unit (CPU), logic, or processor 510. In some embodiments, the processor 510 may include one or more functional unit blocks (FUBs) or combinational logic blocks (CLBs) 515. In such an embodiment, a combinational logic block may include various Boolean logic operations (e.g., NAND, NOR, NOT, XOR), stabilizing logic devices (e.g., flip-flops, latches), other logic devices, or a combination thereof. These combinational logic operations may be configured in simple or complex fashion to process input signals to achieve a desired result. It is understood that while a few illustrative examples of synchronous combinational logic operations are described, the disclosed subject matter is not so limited and may include asynchronous operations, or a mixture thereof. In one embodiment, the combinational logic operations may comprise a plurality of complementary metal oxide semiconductors (CMOS) transistors. In various embodiments, these CMOS transistors may be arranged into gates that perform the logical operations; although it is understood that other technologies may be used and are within the scope of the disclosed subject matter.

The information processing system 500 according to the disclosed subject matter may further include a volatile memory 520 (e.g., a Random Access Memory (RAM)). The information processing system 500 according to the disclosed subject matter may further include a non-volatile memory 530 (e.g., a hard drive, an optical memory, a NAND or Flash memory). In some embodiments, either the volatile memory 520, the non-volatile memory 530, or a combination or portions thereof may be referred to as a “storage medium”. In various embodiments, the volatile memory 520 and/or the non-volatile memory 530 may be configured to store data in a semi-permanent or substantially permanent form.

In various embodiments, the information processing system 500 may include one or more network interfaces 540 configured to allow the information processing system 500 to be part of and communicate via a communications network. Examples of a Wi-Fi protocol may include, but are not limited to, Institute of Electrical and Electronics Engineers (IEEE) 802.11g, IEEE 802.11n. Examples of a cellular protocol may include, but are not limited to: IEEE 802.16m (a.k.a. Wireless-MAN (Metropolitan Area Network) Advanced, Long Term Evolution (LTE) Advanced, Enhanced Data rates for GSM (Global System for Mobile Communications) Evolution (EDGE), Evolved High-Speed Packet Access (HSPA+). Examples of a wired protocol may include, but are not limited to, IEEE 802.3 (a.k.a. Ethernet), Fibre Channel, Power Line communication (e.g., HomePlug, IEEE 1901). It is understood that the above are merely a few illustrative examples to which the disclosed subject matter is not limited.

The information processing system 500 according to the disclosed subject matter may further include a user interface unit 550 (e.g., a display adapter, a haptic interface, a human interface device). In various embodiments, this user interface unit 550 may be configured to either receive input from a user and/or provide output to a user. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

In various embodiments, the information processing system 500 may include one or more other devices or hardware components 560 (e.g., a display or monitor, a keyboard, a mouse, a camera, a fingerprint reader, a video processor). It is understood that the above are merely a few illustrative examples to which the disclosed subject matter is not limited.

The information processing system 500 according to the disclosed subject matter may further include one or more system buses 505. In such an embodiment, the system bus 505 may be configured to communicatively couple the processor 510, the volatile memory 520, the non-volatile memory 530, the network interface 540, the user interface unit 550, and one or more hardware components 560. Data processed by the processor 510 or data inputted from outside of the non-volatile memory 530 may be stored in either the non-volatile memory 530 or the volatile memory 520.

In various embodiments, the information processing system 500 may include or execute one or more software components 570. In some embodiments, the software components 570 may include an operating system (OS) and/or an application. In some embodiments, the OS may be configured to provide one or more services to an application and manage or act as an intermediary between the application and the various hardware components (e.g., the processor 510, a network interface 540) of the information processing system 500. In such an embodiment, the information processing system 500 may include one or more native applications, which may be installed locally (e.g., within the non-volatile memory 530) and configured to be executed directly by the processor 510 and directly interact with the OS. In such an embodiment, the native applications may include pre-compiled machine executable code. In some embodiments, the native applications may include a script interpreter (e.g., C shell (csh), AppleScript, AutoHotkey) or a virtual execution machine (VM) (e.g., the Java Virtual Machine, the Microsoft Common Language Runtime) that are configured to translate source or object code into executable code which is then executed by the processor 510.

The semiconductor devices described above may be encapsulated using various packaging techniques. For example, semiconductor devices constructed according to principles of the disclosed subject matter may be encapsulated using any one of a package on package (POP) technique, a ball grid arrays (BGAs) technique, a chip scale packages (CSPs) technique, a plastic leaded chip carrier (PLCC) technique, a plastic dual in-line package (PDIP) technique, a die in waffle pack technique, a die in wafer form technique, a chip on board (COB) technique, a ceramic dual in-line package (CERDIP) technique, a plastic metric quad flat package (PMQFP) technique, a plastic quad flat package (PQFP) technique, a small outline package (SOIC) technique, a shrink small outline package (SSOP) technique, a thin small outline package (TSOP) technique, a thin quad flat package (TQFP) technique, a system in package (SIP) technique, a multi-chip package (MCP) technique, a wafer-level fabricated package (WFP) technique, a wafer-level processed stack package (WSP) technique, or other technique as will be known to those skilled in the art.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

In various embodiments, a computer readable medium may include instructions that, when executed, cause a device to perform at least a portion of the method steps. In some embodiments, the computer readable medium may be included in a magnetic medium, optical medium, other medium, or a combination thereof (e.g., CD-ROM, hard drive, a read-only memory, a flash drive). In such an embodiment, the computer readable medium may be a tangibly and non-transitorily embodied article of manufacture.

While the principles of the disclosed subject matter have been described with reference to example embodiments, it will be apparent to those skilled in the art that various changes and modifications may be made thereto without departing from the spirit and scope of these disclosed concepts. Therefore, it should be understood that the above embodiments are not limiting, but are illustrative only. Thus, the scope of the disclosed concepts are to be determined by the broadest permissible interpretation of the following claims and their equivalents, and should not be restricted or limited by the foregoing description. It is, therefore, to be understood that the appended claims are intended to cover all such modifications and changes as fall within the scope of the embodiments.

What is claimed is:

1. An apparatus comprising:
a decoder circuit configured to detect, within an instruction stream, a first instruction followed by a second instruction, wherein the first instruction takes as input a dividend and a divisor, and wherein the second instruction produces a remainder;
a scheduler circuit configured to:
merge the first and second instructions into a third instruction, wherein the third instruction takes as input the dividend and the divisor, and produces the remainder,
replace, within an instruction pipeline, the first instruction with the third instruction, and
delete, within the instruction pipeline, the second instruction; and
an execution circuit configured to execute the third instruction.

2. The apparatus of claim 1 wherein the first instruction is an integer division instruction, and the second instruction is a multiply-subtract instruction.

3. The apparatus of claim 1, wherein the first instruction produces a quotient, and wherein the third instruction produces the quotient.

4. The apparatus of claim 1, wherein the execution circuit is configured to output the remainder at a same clock cycle as an output of the first instruction would have been produced had the first instruction not been replaced in the instruction pipeline.

5. The apparatus of claim 1, wherein the decoder circuit comprises a window memory configured to store a portion of the instruction stream; and
wherein the decoder circuit is configured to detect the first and second instructions if both instructions are included by the portion stored in the window memory.

6. The apparatus of claim 1, wherein the decoder circuit comprises a dependency detection circuit, and wherein the dependency detection circuit is configured to:
determine if the second instruction is dependent upon an output of the first circuit,
if so, indicate that the first and second instructions may be merged, and
if not, indicate that the first and second instructions may not be merged.

7. The apparatus of claim 1, wherein the instruction stream includes a compiler hint that indicates whether or not the first and second instructions can be merged; and
wherein the decoder circuit is configured to detect the first instruction followed by the second instruction based, at least in part, upon the compiler hint.

8. The apparatus of claim 1, wherein the instruction stream includes a compiler hint configured to indicate when detection and merging of the first and second instructions is to occur; and
wherein the decoder circuit is configured to detect the first instruction followed by the second instruction based, at least in part, upon the compiler hint.
wherein the scheduler circuit is configured to merge the first and second instructions into the third instruction, based, at least in part, upon the compiler hint.

9. An apparatus comprising:
an instruction pipeline comprising a plurality of pipeline stage circuits, and configured to process a stream of instructions in a partially parallel manner;
wherein the plurality of pipeline stage circuits comprises:
a first circuit configured to detect, within the instruction stream, an integer division instruction followed by a multiply-subtract instruction, wherein the integer division instruction and the multiply-subtract instruction, together, produces a remainder;
a second circuit configured to:
replace, within the instruction stream, the integer division instruction with a modulo instruction, and
delete, within the instruction stream, the multiply-subtract instruction.

10. The apparatus of claim 9, wherein plurality of pipeline stage circuits comprises a third circuit configured to output the remainder at a same pipeline stage as an output of the integer division instruction would have been produced had the integer division instruction not been replaced.

11. The apparatus of claim 9, wherein the first circuit comprises a window memory configured to store a portion of the instruction stream; and
wherein the first circuit is configured to detect the integer division and multiply-subtract instructions if both instructions are included by the portion stored in the window memory.

12. The apparatus of claim 9, wherein the first circuit comprises a dependency detection circuit, and wherein the dependency detection circuit is configured to:
determine if the multiply-subtract instruction is dependent upon an output of the integer division circuit.

13. The apparatus of claim 9, wherein the instruction stream is associated with a compiler hint that indicates whether or not the integer division and multiply-subtract instructions can be merged; and
wherein the first circuit is configured to detect the integer division instruction followed by the multiply-subtract instruction based, at least in part, upon the compiler hint.

14. The apparatus of claim 9, wherein the instruction stream is associated with a compiler hint to turn off the replacement of the integer division interaction with the modulo instruction.

15. The apparatus of claim 9, wherein both the integer division instruction and multiply-subtract instruction are included in a predefined instruction set architecture (ISA), and
wherein the modulo instruction is not included in the predefined instruction set architecture.

16. A method comprising:
detecting, by a first portion of an instruction pipeline circuitry, if a division instruction followed by a subtraction instruction results in a modulo operation;
merging, by a second portion of an instruction pipeline circuitry, the division and subtraction instructions into a merged instruction that, when executed, performs the modulo operation; and
executing, by a third portion of the instruction pipeline circuitry, the merged instruction.

17. The method of claim 16, wherein the first portion includes a decode circuit;
wherein the second portion includes a circuit selected from a group comprising: the decode circuit, a rename circuit, a reorder circuit, and a scheduler circuit.

18. The method of claim 16, wherein detecting includes determining if the division instruction may be merged with the subtraction instruction without violating a dependency rule; and
wherein the determining the violation of the dependency rule includes determining dependencies between a plurality of instructions included within a window of instructions.

19. The method of claim 18, wherein detecting includes determining the violation of the dependency rule includes basing the determination, at least in part, upon one or more compiler hints associated with one or more of the plurality of instructions.

20. The method of claim 19, further including adding compiler hints to a stream of instructions, wherein the compiler hints aid in the determining of the violation of the dependency rule.
